(19) United States
(12) Patent Application Publication
(10) Pub. No.: US 2025/0378380 A1
(43) Pub. Date: Dec. 11, 2025

(54) INFORMATION PROCESSING APPARATUS

(71) Applicant: NEC Corporation, Tokyo (JP)

(72) Inventors: Yoichi Sasaki, Tokyo (JP); Yuzuru Okajima, Tokyo (JP)

(73) Assignee: NEC Corporation, Tokyo (JP)

(21) Appl. No.: 19/226,292

(22) Filed: Jun. 3, 2025

(30) Foreign Application Priority Data
Jun. 10, 2024 (JP) 2024-093799

(51) Int. Cl. G06N 20/00; G06N 5/022

(52) U.S. Cl. CPC G06N 20/00; G06N 5/022

(57) ABSTRACT

An information processing apparatus of the present disclosure includes: a generating unit configured to, based on prediction performance on training data by a rule set model composed of a combination of rules making predetermined prediction on the training data, generate a plurality of rule set models satisfying a constraint rule count representing a constraint on a combinative rule count; and a selecting unit configured to, based on a position corresponding to the rule set model in a space with an axis of prediction performance and an axis of rule count, select and output a model group composed of a combination of the rule set models satisfying a constraint model count representing a constraint on a combinative model count.

### INCORPORATION BY REFERENCE

This application is based upon and claims the benefit of priority from Japanese patent application No. 2024-093799, filed on Jun. 10, 2024, the disclosure of which is incorporated herein in its entirety by reference.

### TECHNICAL FIELD

The present disclosure relates to an information processing apparatus.

### BACKGROUND ART

It is practiced in various fields to make a prediction on input data using a machine learning model. Here, the machine learning model includes, for example, a rule-based model that is easy to interpret as described in Patent Literature 1. In the rule-based model, it is practiced to learn a rule set model composed of a combination of a plurality of rules using a training case set.

### CITATION LIST

### Patent Literature

[Patent Literature 1] WO2022/044221

### SUMMARY OF INVENTION

### Technical Problem

However, in the rule set model composed of a combination of a plurality of rules, there is a trade-off relation between prediction performance and interpretability. For this reason, there arises a problem that it is difficult to find an appropriate rule set model with high prediction performance and interpretability.

Accordingly, an object of the present disclosure is to solve the abovementioned problem that it is difficult to find an appropriate rule set model.

### Solution to Problem

An information processing apparatus as an aspect of the present disclosure includes: a generating unit configured to, based on prediction performance on training data by a rule set model composed of a combination of rules making predetermined prediction on the training data, generate a plurality of rule set models satisfying a constraint rule count representing a constraint on a combinative rule count; and a selecting unit configured to, based on a position corresponding to the rule set model in a space with an axis of prediction performance and an axis of rule count, select and output a model group composed of a combination of the rule set models satisfying a constraint model count representing a constraint on a combinative model count.

Further, an information processing method as an aspect of the present disclosure includes: based on prediction performance on training data by a rule set model composed of a combination of rules making predetermined prediction on the training data, generating a plurality of rule set models satisfying a constraint rule count representing a constraint on a combinative rule count; and based on a position corresponding to the rule set model in a space with an axis of prediction performance and an axis of rule count, selecting and outputting a model group composed of a combination of the rule set models satisfying a constraint model count representing a constraint on a combinative model count.

Further, a program as an aspect of the present disclosure includes instructions for causing a computer to execute processes to: based on prediction performance on training data by a rule set model composed of a combination of rules making predetermined prediction on the training data, generate a plurality of rule set models satisfying a constraint rule count representing a constraint on a combinative rule count; and based on a position corresponding to the rule set model in a space with an axis of prediction performance and an axis of rule count, select and output a model group composed of a combination of the rule set models satisfying a constraint model count representing a constraint on a combinative model count.

### Advantageous Effects of Invention

With the configurations as described above, the present disclosure can easily find an appropriate rule set model.

### BRIEF DESCRIPTION OF DRAWINGS

FIG. 1 is a block diagram showing an example of a configuration of an information processing apparatus according to the present disclosure.

FIG. 2 is a diagram showing an example of a state of processing by the information processing apparatus according to the present disclosure.

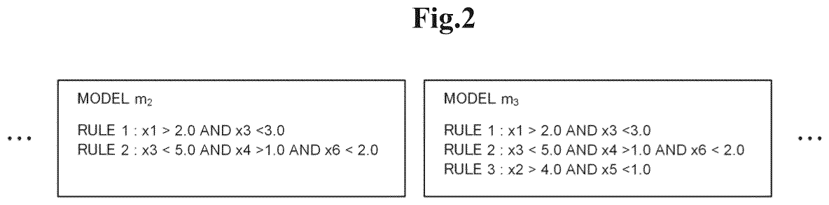

FIG. 3 is a diagram showing an example of a state of processing by the information processing apparatus according to the present disclosure.

FIG. 4 is a diagram showing an example of a state of processing by the information processing apparatus according to the present disclosure.

FIG. 5 is a flowchart showing an example of processing operation of the information processing apparatus according to the present disclosure.

FIG. 6 is a block diagram showing an example of a hardware configuration of an information processing apparatus according to the present disclosure.

FIG. 7 is a block diagram showing an example of a configuration of the information processing apparatus according to the present disclosure.

### EXAMPLE EMBODIMENTS

### First Example Embodiment

A first example embodiment of the present disclosure will be described with reference to the drawings. The drawings may be related to any example embodiment.

An information processing apparatus 10 in this example embodiment generates a rule-based model using training case data. In particular, in this example embodiment, the information processing apparatus 10 generates a rule set model composed of a combination of rules and furthermore selects and outputs a model group composed of a combination of a plurality of rule set models with high prediction performance and interpretability. Consequently, the user can receive presentation of a model group composed of a plurality of rule set models with high prediction performance and interpretability and can use a rule set model of the model group. In this example embodiment, the high interpretability of a rule set model refers to a small number of rules included by a rule set model.

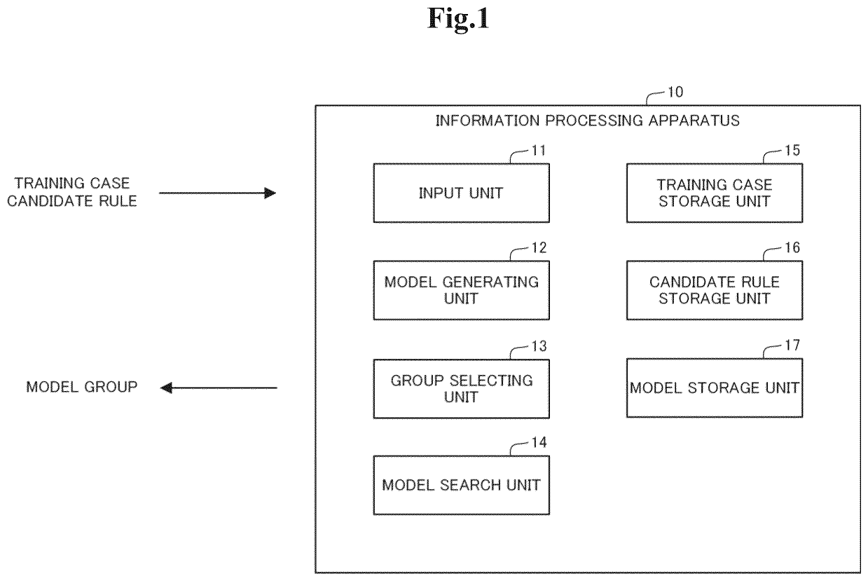

The information processing apparatus 10 is configured with one or a plurality of information processing apparatuses each including an arithmetic logic unit and a memory unit. Then, as shown in FIG. 1, the information processing apparatus 10 includes an input unit 11, a model generating unit 12, a group selecting unit 13, and a model search unit 14. The respective functions of the input unit 11, the model generating unit 12, the group selecting unit 13, and the model search unit 14 can be implemented by execution of a program for implementing the respective functions stored in the memory unit by the arithmetic logic unit. Moreover, the information processing apparatus 10 includes a training case storage unit 15, a candidate rule storage unit 16, and a model storage unit 17. The training case storage unit 15, the candidate rule storage unit 16, and the model storage unit 17 are configured with the memory unit. The function and operation of each of the components will be described below.

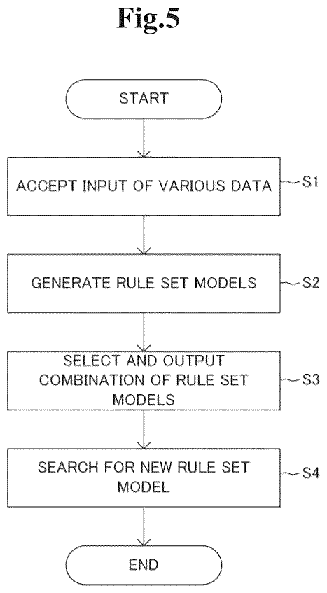

The input unit 11 receives input of a set of training case data (training data) used for training a rule set model by the information processing apparatus 10 and stores it into the training case storage unit 15 (step S1 of FIG. 5). For example, the training case data includes pairs of explanatory variables (x1, x2, . . . ) and objective variable (y).

Further, the input unit 11 receives input of a set of candidate rules (rules) that the information processing apparatus 10 makes a prediction on the training case data, and stores it into the candidate rule storage unit 16 (step S1 of FIG. 5). For example, the candidate rule includes a condition (IF) and a prediction value (THEN), for example, a condition of explanatory variables like “x3<5.0 AND x4>1.5 AND x6<2.0” and a prediction value. Below, only the condition is illustrated as the candidate rule.

Further, the input unit 11 receives input of a constraint rule count, which is a parameter used at the time of generating the rule set model by the information processing apparatus 10 (step S1 of FIG. 5). For example, the constraint rule count is a maximum value K of the number of combinative rules that can be included by the rule set model. The constraint rule count may be a numerical value that lists the number of combinative rules that can be included by the rule set model, or may be any information that represents the allowable number of rules. In this example embodiment, it is assumed that constraint rule count K=10 is input as an example.

Further, the input unit 11 receives input of a constraint model count, which is a parameter used at the time of selecting a model group composed of a combination of rule set models by the information processing apparatus 10 (step S1 of FIG. 5). For example, the constraint model count is a number S of combinative models that can be included by the model group. The constraint model count S may be a numerical value that lists the number of combinative models that can be included by the model group, or may be any information that represents the allowable number of models. In this example embodiment, it is assumed that constraint model count S=4 is input as an example.

The data received by the input unit 11 described above, that is, data such as the training case data and the candidate rule may be stored in advance in the information processing apparatus 10.

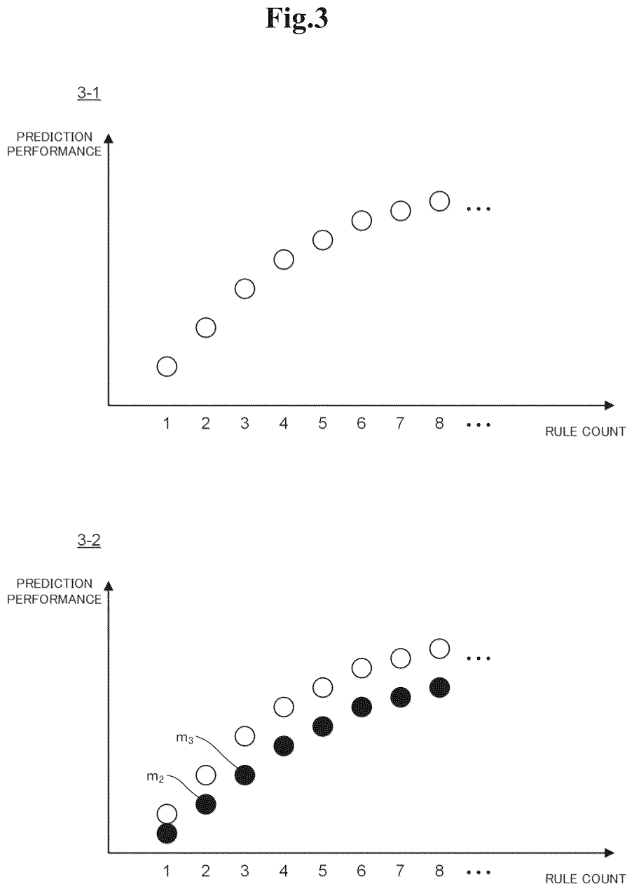

The model generating unit 12 (generating unit) generates a plurality of rule set models each composed of a combination of candidate rules (step S2 of FIG. 5). At this time, the model generating unit 12 generates a rule set model obtained by combining a rule count r of candidate rules that is up to the maximum value K as the constraint rule count described above, based on the performance of prediction on the training case data by the rule set model. In particular, in this example embodiment, the model generating unit 12 generates one rule set model for each rule count r of rules that is equal to or less than the maximum value K as the constraint rule count. For example, in a case where the rule count maximum value K as the constraint rule count is 10, the model generating unit generates a rule set model including each of rule counts r from 1 to 10 of candidate rules. As an example, as shown in FIG. 3, the model generating unit generates a rule set model including two rules (rules 1 and 2) as a rule set model m₂ with rule count r=2 and generates a rule set model including three rules (rules 1, 2, and 3) as a rule set model m₃ with rule count r=3.

More specifically, a method for generating a rule set model by the model generating unit 12 will be described. When generating a rule set model mᵣ for each rule count r equal to or less than the maximum value K as the constraint rule count, the model generating unit 12 generates the rule set model mᵣ by adding a candidate rule by the greedy algorithm. That is to say, when generating the rule set model mᵣ with a target rule count r, the model generating unit 12 selects and adds candidate rules one by one up to the target rule count r by the greedy algorithm and sets the rule set model mᵣ. For example, in a case where the target rule count r is 2, by the greedy algorithm, the model generating unit selects and adds the first candidate rule with high prediction performance and then selects and adds the second candidate rule with high prediction performance, thereby setting a rule set model m₂ including the two candidate rules. In this manner, the model generating unit generates the rule set model mᵣ including each rule count r of candidate rules on rule counts r=1, 2, . . . , K, respectively.

The model generating unit 12 can generate a rule set model mᵣ having predetermined approximation guarantee for a rule set model having optimal prediction performance by generating a rule set model mᵣ corresponding to each rule count r by the greedy algorithm as described above. That is to say, by the submodularity in an optimization problem of a combination of candidate rules as described above, it is possible to generate a rule set model with an approximation rate α=0.63 with respect to optimal prediction performance. Here, FIG. 3(3-1) shows a coordinate space with the horizontal axis representing a rule count and the vertical axis representing prediction performance and, on the coordinate space, a white circle point is plotted for a rule set model such that prediction performance is considered optimal at each rule count r. Then, FIG. 3(3-2) shows, on the coordinate space, a black circle point plotted for a rule set model mᵣ generated at each rule count r by the greedy algorithm as described above. Thus, the model generating unit 12 generates a rule set model mᵣ having predetermined approximation guarantee for a rule set model having optimal prediction performance at each rule count r. However, the model generating unit 12 is not necessarily limited to generating a rule set model mᵣ by the greedy algorithm, and may generate a rule set model mᵣ by any other methods. At this time, the model generating unit 12 can generate a rule set model mᵣ having predetermined approximation guarantee for a rule set model having optimal prediction performance at each rule count r.

The group selecting unit 13 (selecting unit) selects a model group obtained by combining, of the rule set models mᵣ corresponding to the respective rule counts r generated as described above, a number of rule set models mᵣ that is a set model count S as the constraint model count (step S3 of FIG. 5). To be specific, the group selecting unit 13 selects a combination of the model count S of rule set models mᵣ, based on the positions of points corresponding to the respective rule set models mᵣ on the coordinate space with the axes representing rule count and prediction performance, respectively, as shown in FIG. 3(3-2) described above. For example, in a case where the model count S as the constraint model count is 4, the group selecting unit selects a model group composed of a combination of four rule set models mᵣ in accordance with the positions of points corresponding to the respective rule set models mᵣ on the coordinate space. The constraint model count S may represent the maximum value or the range of the selected model count and, in this case, the group selecting unit 13 may select a number of rule set models that is equal to or less than the maximum value or within the range.

More specifically, a method for selecting a model group by the group selecting unit 13 will be described. The group selecting unit 13 selects the model count S of rule set models mᵣ so as to maximize the area of a region A formed by the set model count S of points among the points corresponding to the respective rule set models mᵣ on the coordinate space as shown in FIG. 3(3-1). At this time, the region whose area is to be maximized is a region formed by the point of the rule set model mᵣ and a fixed point P that is set to a value smaller on the axis of prediction performance and larger on the axis of rule count than the point of the rule set model, for example, a region surrounded by sides parallel to the axes passing through the point of the rule set model mᵣ and the fixed point P, respectively. For example, the fixed point P is set to coordinates (K′, 0) with 0 as prediction performance and a value K′ larger than the maximum value K as rule count on the coordinate space. Then, the group selecting unit 13 adds rule set model points one by one so that the area of the region A formed by being surrounded by sides parallel to the axes passing through the rule set model points and the fixed point P is maximized by the greedy algorithm, and finally selects a model group including S rule set models mᵣ. That is to say, the group selecting unit 13 selects the point of the rule set model mᵣ so as to maximize a hypervolume index function corresponding to the area on the coordinate space, as a hypervolume subset selection problem.

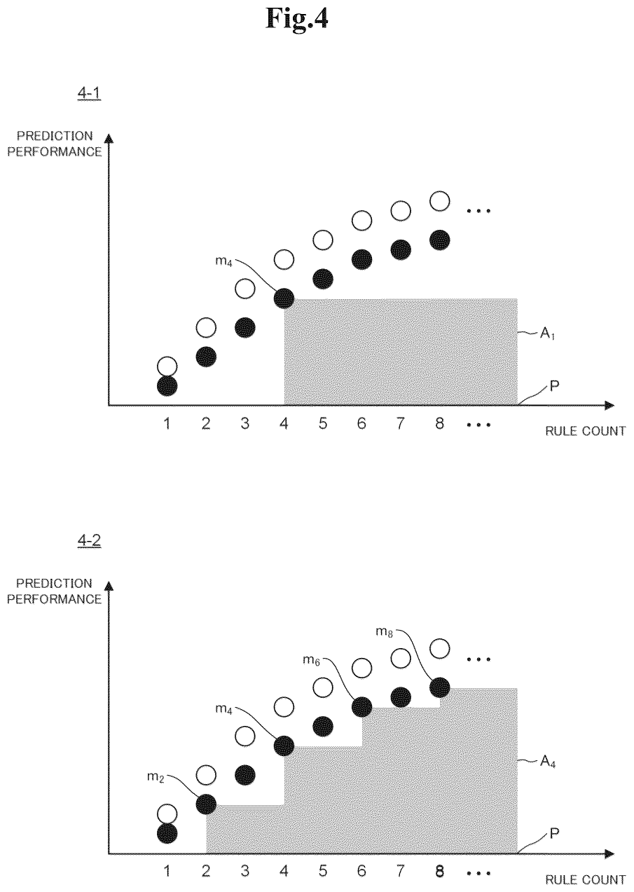

An example of a group model selection process by the group selecting unit 13 will be described with reference to FIG. 4. Here, it is assumed that the constraint model count S is 4. The group selecting unit 13 first selects, by the greedy algorithm, a point of one rule set model mᵣ such that the area of a region A₁ formed by a point of one rule set model and a fixed point P (K′,0), that is, the area of the region A₁ surrounded by sides parallel to axes passing through the point of the rule set model and the fixed point P, respectively, is maximized. For example, as shown in gray in FIG. 4(4-1), a point of a rule set model m₄ is selected based on the area of the rectangular region A₁ with the point of the rule set model m₄ and the fixed point P as opposite vertices. Subsequently, the group selecting unit 13 adds and selects, one by one, points of rule set models mᵣ such that the region A is maximized by the greedy algorithm, thereby selecting the points of four rule set models mᵣ. Consequently, four rule set models m₂, m₄, m₆, and m₈ are selected based on the area of a region A₄ shown in gray in FIG. 4(4-2).

The group selecting unit 13 can select a rule set model mᵣ having predetermined approximation guarantee with respect to the area of the region A that can be maximum by selecting a rule set model by the greedy algorithm as described above. That is to say, by the submodularity in an optimization problem of combination of rule set models as mentioned above, it is possible to select a rule set model with an approximation rate β=0.63 with respect to the maximum area. Then, in conjunction with the approximation rate α at the time of generating a rule set model by the above-described model generating unit 12, the selection of a rule set model by the group selecting unit 13 has approximation guarantee of αβ with respect to the optimal selection. However, the group selecting unit 13 is not necessarily limited to selecting a rule set model mᵣ by the greedy algorithm, and may select a rule set model mᵣ by any other methods.

The group selecting unit 13 outputs a model group composed of a combination of rule set models mᵣ selected as described above to the user (step S3 of FIG. 5). For example, in the example described above, a model group including the four rule set models m₂, m₄, m₆, and ma is output to the user. Consequently, the user can use any of the rule set models included by the output model group for an actual operation case and make a prediction in such a case. The group selecting unit 13 stores the model group composed of the combination of the selected rule set models mᵣ into the model storage unit 17.

The model search unit 14 (search unit) performs a solution process on training case data using the respective rule set models selected as described above composing the model group as an initial solution, and searches for a new rule set model (step S4 of FIG. 5). To be specific, the model search unit 14 searches for a solution on training case data for each of the rule set models and, in a case where the prediction performance increases by changing a candidate rule included by the rule set model, changes the candidate rule to update the rule set model.

Then, in a case where the rule set model is updated, the selection of a rule set model composing a model group by the group selecting unit 13 may be performed again. In a case where, by the update of the rule set model, a new rule set model is selected and the model group is updated, the group selecting unit 13 outputs the model group.

As described above, in the present disclosure, it is possible to find an appropriate rule set model with high prediction performance and interpretability and present it to the user. That is to say, since the number of rules included by a rule set model is small, it is possible to find a rule set model with high interpretability and high prediction performance. In addition, in the present disclosure, since a plurality of rule set models are selected by the greedy algorithm, the difference between the respective rule set models can be easily understood.

### Second Example Embodiment

Next, a second example embodiment of the present disclosure will be described with reference to the drawings. In this example embodiment, the overview of the information processing apparatus and so forth described in the above example embodiment is shown. The drawings may be related to any of the example embodiments.

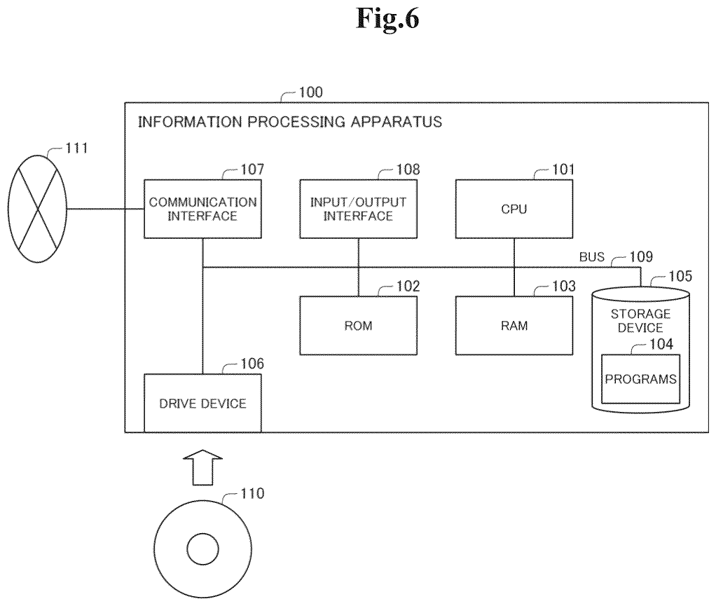

First, a hardware configuration of an information processing apparatus 100 in the present disclosure will be described. The information processing apparatus 100 is configured with a general information processing apparatus and, as an example, as shown in FIG. 6, has the following hardware configuration including:
a CPU (Central Processing Unit) 101 (arithmetic logic unit);
a ROM (Read Only Memory) 102 (memory unit);
a RAM (Random Access Memory) 103 (memory unit);
programs 104 loaded into the RAM 103;
a storage device 105 storing the programs 104;
a drive device 106 that performs reading from and writing into a storage medium 110 external to the information processing apparatus;
a communication interface 107 connected to a communication network 111 external to the information processing apparatus;
an input/output interface 108 that performs input/output of data; and
a bus 109 connecting the components.

FIG. 6 shows an example of the hardware configuration of the information processing apparatus serving as the information processing apparatus 100, and the hardware configuration of the information processing apparatus is not limited to the abovementioned case. For example, the information processing apparatus may be configured with part of the abovementioned configuration, such as not having the drive device 106. Moreover, the information processing apparatus may use a GPU (Graphic Processing Unit), a DSP (Digital Signal Processor), an MPU (Micro Processing Unit), an FPU (Floating point number Processing Unit), a PPU (Physics Processing Unit), a TPU (Tensor Processing Unit), a quantum processor, a microcontroller, or a combination of these, instead of the abovementioned CPU.

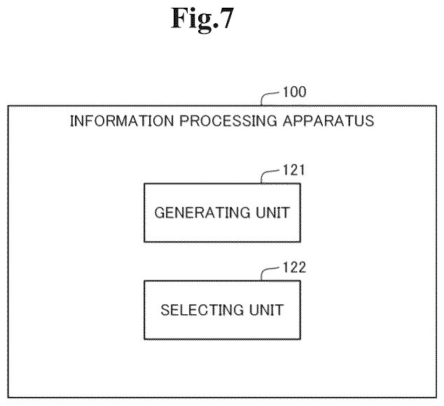

Then, the information processing apparatus 100 can construct and include a generating unit 121 and a selecting unit 122 shown in FIG. 7 by acquisition and execution of the programs 104 by the CPU 101. The programs 104 are, for example, stored in advance in the storage device 105 or the ROM 102, and are loaded into the RAM 103 and executed by the CPU 101 as necessary. In addition, the programs 104 may be provided to the CPU 101 via the communication network 111, or the programs may be stored in advance in the storage medium 110 and read out by the drive device 106 and provided to the CPU 101. However, the generating unit 121 and the selecting unit 122 described above may be constructed using a dedicated electronic circuit for implementing such means.

The generating unit 121 generates a plurality of rule set models satisfying a constraint rule count representing a constraint on a combinative rule count, based on performance of prediction on training data by a rule set model composed of a combination of rules that makes predetermined prediction on the training data. The selecting unit 122 selects and outputs a model group composed of a combination of the rule set models satisfying a constraint model count representing a constraint on a combinative model count, based on a position corresponding to the rule set model in a space with axes representing prediction performance and a rule count, respectively.

With the configuration as described above of the present disclosure, it is possible to easily find an appropriate rule set model.

At least one or more functions of the functions of the generating unit 121 and the selecting unit 122 described above may be executed by an information processing apparatus installed and connected anywhere on a network, that is, may be executed by so-called cloud computing.

Further, the abovementioned programs can be stored using various types of non-transitory computer-readable mediums and provided to a computer. The non-transitory computer-readable medium includes various types of tangible storage mediums. Examples of the non-transitory computer-readable medium include a magnetic recording medium (e.g., flexible disk, magnetic tape, hard disk drive), a magneto-optical recording medium (e.g., magneto-optical disk), a CD-ROM (read only memory), a CD-R, a CD-R/W, and a semiconductor memory (e.g., mask ROM, PROM (programmable ROM), EPROM (erasable PROM), flash ROM, RAM (random access memory)). In addition, the programs may be provided to the computer by various types of temporary computer-readable mediums. Examples of the temporary computer-readable medium include electrical signals, optical signals, and electromagnetic waves. The temporary computer-readable medium may provide the program to the computer via a wired communication channel such as an electric wire and an optical fiber or via a wireless communication channel.

Although the present disclosure has been described above with reference to the example embodiments, the present disclosure is not limited to the example embodiments described above. The configuration and details of the present disclosure can be changed in a variety of ways that those skilled in the art can understand within the scope of the present disclosure. Then, each of the example embodiments described above can be combined with the other example embodiment as necessary.

### <Supplementary Notes>

The whole or part of the example embodiments disclosed above can be described as the following supplementary notes. Hereinafter, the overview of configurations of an information processing apparatus, an information processing method, and a program in the present disclosure will be described. However, the present disclosure is not limited to the configurations described in the following supplementary notes.

All or some of the configurations described in Supplementary Notes 2 to 8 dependent on Supplementary Note 1 described below and the functions by such configurations may be dependent on other Supplementary Notes 9 and 17 by the same dependence as Supplementary Notes 2 to 8. Furthermore, not limited to Supplementary Notes 1, 9, or 17, within the scope of the example embodiments described above, all or some of the configurations described as supplementary notes and functions by such configurations may be dependent on hardware, software, various recording means for recording software, or system.

### (Supplementary Note 1)

An information processing apparatus comprising:
a generating unit configured to, based on prediction performance on training data by a rule set model composed of a combination of rules making predetermined prediction on the training data, generate a plurality of rule set models satisfying a constraint rule count representing a constraint on a combinative rule count; and
a selecting unit configured to, based on a position corresponding to the rule set model in a space with an axis of prediction performance and an axis of rule count, select and output a model group composed of a combination of the rule set models satisfying a constraint model count representing a constraint on a combinative model count.

### (Supplementary Note 2)

The information processing apparatus according to supplementary note 1, wherein
the generating unit is configured to, for each rule count satisfying the constraint rule count, generate the rule set model such that the prediction performance on the training data is determined to be higher than a preset criterion.

### (Supplementary Note 3)

The information processing apparatus according to supplementary note 2, wherein
the generating unit is configured to generate the rule set model for each of rule counts from 1 to a maximum value set as the constraint rule count.

### (Supplementary Note 4)

The information processing apparatus according to supplementary note 1, wherein
the selecting unit is configured to select and output the model group based on a size of a region formed with a point representing a position corresponding to each of the rule set models composing a combination of the model count of rule set models satisfying the constraint model count in the space.

### (Supplementary Note 5)

The information processing apparatus according to supplementary note 4, wherein
the selecting unit is configured to select and output the model group such that a region is determined to be larger than a preset criterion, the region being formed by the point corresponding to each of the rule set models composing the combination of the model count of rule set models satisfying the constraint model count and a fixed point set to a value smaller on the axis of prediction performance and larger on the axis of rule count than values of the point in the space.

### (Supplementary Note 6)

The information processing apparatus according to supplementary note 1, wherein
the generating unit is configured to generate the rule set model having predetermined approximation guarantee with respect to the prediction performance of the optimal rule set model.

### (Supplementary Note 7)

The information processing apparatus according to supplementary note 1, wherein
the generating unit is configured to select each of the rules by greedy algorithm based on prediction performance of the rule and generate the rule set model including the rule.

### (Supplementary Note 8)

The information processing apparatus according to supplementary note 1, comprising
a search unit configured to perform solution on the training data using the rule set models composing the selected model group as an initial solution, and search for the new rule set model.

### (Supplementary Note 9)

An information processing method comprising
based on prediction performance on training data by a rule set model composed of a combination of rules making predetermined prediction on the training data, generating a plurality of rule set models satisfying a constraint rule count representing a constraint on a combinative rule count; and
based on a position corresponding to the rule set model in a space with an axis of prediction performance and an axis of rule count, selecting and outputting a model group composed of a combination of the rule set models satisfying a constraint model count representing a constraint on a combinative model count.

### (Supplementary Note 10)

The information processing method according to supplementary note 9, comprising
for each rule count satisfying the constraint rule count, generating the rule set model such that the prediction performance on the training data is determined to be higher than a preset criterion.

### (Supplementary Note 11)

The information processing method according to supplementary note 10, comprising
generating the rule set model for each of rule counts from 1 to a maximum value set as the constraint rule count.

### (Supplementary Note 12)

The information processing method according to supplementary note 9, comprising
selecting and outputting the model group based on a size of a region formed with a point representing a position corresponding to each of the rule set models composing a combination of the model count of rule set models satisfying the constraint model count in the space.

### (Supplementary Note 13)

The information processing method according to supplementary note 12, comprising
selecting and outputting the model group such that a region is determined to be larger than a preset criterion, the region being formed by the point corresponding to each of the rule set models composing the combination of the model count of rule set models satisfying the constraint model count and a fixed point set to a value smaller on the axis of prediction performance and larger on the axis of rule count than values of the point in the space.

### (Supplementary Note 14)

The information processing method according to supplementary note 9, comprising
generating the rule set model having predetermined approximation guarantee with respect to the prediction performance of the optimal rule set model.

### (Supplementary Note 15)

The information processing method according to supplementary note 9, comprising
selecting each of the rules by greedy algorithm based on prediction performance of the rule and generating the rule set model including the rule.

### (Supplementary Note 16)

The information processing method according to supplementary note 9, comprising
performing solution on the training data using the rule set models composing the selected model group as an initial solution, and searching for the new rule set model.

### (Supplementary Note 17)

A program comprising instructions for causing a computer to execute processes to:
based on prediction performance on training data by a rule set model composed of a combination of rules making predetermined prediction on the training data, generate a plurality of rule set models satisfying a constraint rule count representing a constraint on a combinative rule count; and
based on a position corresponding to the rule set model in a space with an axis of prediction performance and an axis of rule count, select and output a model group composed of a combination of the rule set models satisfying a constraint model count representing a constraint on a combinative model count.

### REFERENCE SIGNS LIST

10 information processing apparatus
11 input unit
12 model generating unit
13 group selecting unit
14 model search unit
15 training case storage unit
16 candidate rule storage unit
17 model storage unit
100 information processing apparatus
101 CPU
102 ROM
103 RAM
104 programs
105 storage device
106 drive device
107 communication interface
108 input/output interface
109 bus
110 storage medium
111 communication network
121 generating unit
122 selecting unit

1. An information processing apparatus comprising:
at least one memory storing processing instructions; and
at least one processor configured to execute the processing instructions to:
based on prediction performance on training data by a rule set model composed of a combination of rules making predetermined prediction on the training data, generate a plurality of rule set models satisfying a constraint rule count representing a constraint on a combinative rule count; and
based on a position corresponding to the rule set model in a space with an axis of prediction performance and an axis of rule count, select and output a model group composed of a combination of the rule set models satisfying a constraint model count representing a constraint on a combinative model count.

2. The information processing apparatus according to claim 1, wherein the at least one processor is configured to execute the processing instructions to
for each rule count satisfying the constraint rule count, generate the rule set model such that the prediction performance on the training data is determined to be higher than a preset criterion.

3. The information processing apparatus according to claim 2, wherein the at least one processor is configured to execute the processing instructions to
generate the rule set model for each of rule counts from 1 to a maximum value set as the constraint rule count.

4. The information processing apparatus according to claim 1, wherein the at least one processor is configured to execute the processing instructions to
select and output the model group based on a size of a region formed with a point representing a position corresponding to each of the rule set models composing a combination of the model count of rule set models satisfying the constraint model count in the space.

5. The information processing apparatus according to claim 4, wherein the at least one processor is configured to execute the processing instructions to
select and output the model group such that a region is determined to be larger than a preset criterion, the region being formed by the point corresponding to each of the rule set models composing the combination of the model count of rule set models satisfying the constraint model count and a fixed point set to a value smaller on the axis of prediction performance and larger on the axis of rule count than values of the point in the space.

6. The information processing apparatus according to claim 1, wherein the at least one processor is configured to execute the processing instructions to
generate the rule set model having predetermined approximation guarantee with respect to the prediction performance of the optimal rule set model.

7. The information processing apparatus according to claim 1, wherein the at least one processor is configured to execute the processing instructions to
select each of the rules by greedy algorithm based on prediction performance of the rule and generate the rule set model including the rule.

8. The information processing apparatus according to claim 1, wherein the at least one processor is configured to execute the processing instructions to
perform solution on the training data using the rule set models composing the selected model group as an initial solution, and search for the new rule set model.

9. An information processing method comprising
based on prediction performance on training data by a rule set model composed of a combination of rules making predetermined prediction on the training data, generating a plurality of rule set models satisfying a constraint rule count representing a constraint on a combinative rule count; and
based on a position corresponding to the rule set model in a space with an axis of prediction performance and an axis of rule count, selecting and outputting a model group composed of a combination of the rule set models satisfying a constraint model count representing a constraint on a combinative model count.

10. The information processing method according to claim 9, comprising
for each rule count satisfying the constraint rule count, generating the rule set model such that the prediction performance on the training data is determined to be higher than a preset criterion.

11. The information processing method according to claim 10, comprising
generating the rule set model for each of rule counts from 1 to a maximum value set as the constraint rule count.

12. The information processing method according to claim 9, comprising
selecting and outputting the model group based on a size of a region formed with a point representing a position corresponding to each of the rule set models composing a combination of the model count of rule set models satisfying the constraint model count in the space.

13. The information processing method according to claim 12, comprising
selecting and outputting the model group such that a region is determined to be larger than a preset criterion, the region being formed by the point corresponding to each of the rule set models composing the combination of the model count of rule set models satisfying the constraint model count and a fixed point set to a value smaller on the axis of prediction performance and larger on the axis of rule count than values of the point in the space.

14. The information processing method according to claim 9, comprising
generating the rule set model having predetermined approximation guarantee with respect to the prediction performance of the optimal rule set model.

15. The information processing method according to claim 9, comprising
selecting each of the rules by greedy algorithm based on prediction performance of the rule and generating the rule set model including the rule.

16. The information processing method according to claim 9, comprising
performing solution on the training data using the rule set models composing the selected model group as an initial solution, and searching for the new rule set model.

17. A non-transitory computer-readable storage medium storing a program, the program comprising instructions for causing a computer to execute processes to:
based on prediction performance on training data by a rule set model composed of a combination of rules making predetermined prediction on the training data, generate a plurality of rule set models satisfying a constraint rule count representing a constraint on a combinative rule count; and
based on a position corresponding to the rule set model in a space with an axis of prediction performance and an axis of rule count, select and output a model group composed of a combination of the rule set models satisfying a constraint model count representing a constraint on a combinative model count.
